(19) United States
(12) Patent Application Publication
(10) Pub. No.: US 2012/0063282 A1
(43) Pub. Date: Mar. 15, 2012

(54) Systems and Methods for Improved Control of Spindle Speed During Optical Media Seek Operations

(75) Inventors: Cong Cao, Shenzhen (CN); CaiZhi Zhu, Shenzhen (CN); BoWen Chen, Shenzhen (CN)

(73) Assignee: ZORAN CORPORATION, SUNNYVILLE, CA (US)

(21) Appl. No.: 12/521,462

(22) PCT Filed: Jun. 1, 2009
(86) PCT No.: PCT/CN09/00615

§ 371 Date: Jun. 26, 2009

(51) Int. Cl. G11B 19/26

(52) U.S. Cl. 369/47.4; G9B/19.042

(57) ABSTRACT

Improved control of spindle speed during optical media seek operations is provided by adjusting the spindle motor speed during the actual optical pickup unit movement. In response to receiving a seek instruction to move an optical pickup unit to a target position, the current signal frequency corresponding to a current spindle motor speed may be determined. A target signal frequency corresponding to a desired spindle motor speed at the target position may also be computed. Thereafter, the current spindle motor speed may be adjusted towards the desired spindle motor speed prior to the optical pickup unit reaching the target position.

### FIELD OF THE INVENTION

The present invention relates in general to optical media seek operations, and in particular to controlling spindle speed during longer jumps based on the required spindle speed at the target position.

### BACKGROUND

During optical media seek operations, it is desirable for the optical media player's optical pickup unit (OPU) to move to the target position and complete track pull-in as quickly as possible so as to begin reading the desired data with minimal delay. Currently, a constant voltage is applied to the spindle motor while the OPU is seeking to the new position. However, since the required spindle speed is different for different OPU positions along the media's surface, a proportional-plus-integral (PI) controller is then typically used to achieve the required spindle motor rotational speed once the OPU has reached the target position. Unfortunately, and particularly in the case of long jumps, the seek process (including track pull-in) can consume a significant amount of time (e.g., ≈4 seconds) due to the substantial change in the desired spindle motor speed between the current or initial OPU position, on the one hand, and the target position, on the other hand.

Thus, there is a need in the art for systems and methods for improved control of spindle speed during optical media seek operations such that the track pull-in time may be reduced, and correspondingly reduce the required seek time.

### BRIEF SUMMARY OF THE INVENTION

Disclosed and claimed herein are systems and methods improved control of spindle speed during optical media seek operations. In one embodiment, a method includes receiving a seek instruction to move an optical pickup unit to a target position on an optical media surface, determining a current signal frequency corresponding to a current spindle motor speed, determining a target signal frequency corresponding to a desired spindle motor speed at the target position, and adjusting the current spindle motor speed towards the desired spindle motor speed prior to the optical pickup unit reaching the target position.

In one embodiment, a system for controlling a spindle motor during optical media seek operations includes a frequency generation (FG) sensor configured to output a current FG signal corresponding to a current spindle motor speed, and a controller coupled to the FG sensor. The controller may be configured to receive the current FG signal from the FG sensor, to determine a current signal frequency for the current FG signal, and to determine a target signal frequency corresponding to a desired spindle motor speed at the target position on an optical media surface, where the target position corresponds to a seek instruction to move an optical pickup unit to the target position. The controller may be further configured to adjust the current spindle motor speed towards the desired spindle motor speed prior to the optical pickup unit reaching the target position.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1A depicts one embodiment of a process for implementing one or more aspects of the invention;

FIG. 1B depicts a another embodiment of a process for implementing one or more aspects of the invention;

FIGS. 2A-2B depict track and pits lengths and orientations for common optical media types;

FIG. 3 depicts a constant angular velocity control system configured to implement one or more embodiments of the invention;

FIG. 4A depicts a screenshot of various signal captures corresponding to a typical optical pickup unit jump; and

FIG. 4B depicts a screenshot of signal captures corresponding to an optical pickup unit jump performed in accordance with the principles of the invention.

### DETAILED DESCRIPTION OF EXEMPLARY EMBODIMENTS

### Overview and Terminology

Unlike typical control systems, one aspect of the present disclosure is to control and change the spindle motor speed during the actual OPU jumps (i.e., seek operations), rather than applying a constant voltage to the spindle during the jump, and then adjusting the spindle speed only after the target position has been reached. In this fashion, the present disclosure decreases the track pull-in time, thereby shortening the overall seek time.

Moreover, it should be appreciated that the present disclosure may relate to Contant Linear Velocity (CLV), Constant Angular Velocity (CAV) or combination CLV/CAV optical drives (e.g., drives capable of operating in either CLV or CAV mode).

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means any of the following: A; B; C; A and B; A and C; B and C; A, B and C. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits

When implemented in software, the elements of the invention are essentially the code segments to perform the necessary tasks. The code segments can be stored in a “processor storage medium,” which includes any medium that can store information. Examples of the processor readable medium include an electronic circuit, a semiconductor memory device, a ROM, a flash memory or other non-volatile memory, a floppy diskette, a CD-ROM, an optical disk, a hard disk, etc.

### Exemplary Embodiments

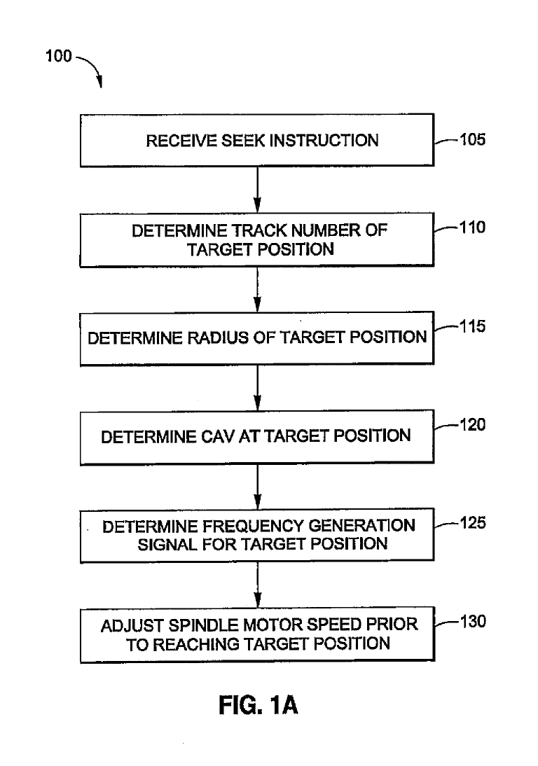

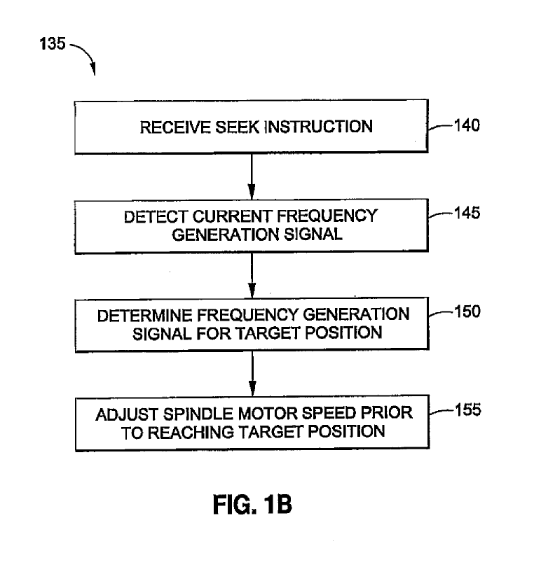

FIG. 1A depicts one embodiment of a process for providing improved control of spindle speed during optical media seek operations. Process 100 assumes the device in question is a CLV device or is otherwise operating in CLV mode. Process 100 begins at block 105 when an optical drive controller receives a seek instruction to move the device's OPU from its current position to a target position along the media's surface. As is generally known, the OPU may be configured with its own power controller, a laser diode, an optical system, and a photosensor. Following receipt of such a seek instruction, process 100 proceeds to block 110 to determine the track number that corresponds to the identified target position.

In order to determine the track number corresponding to the target position at block 110, it is first noted that the radius from the media's center hole to the target position may be calculated using the Physical Sector Numbers (PSN) information and track pitch (i.e., the distance between the centerlines of a pair of adjacent physical tracks measured in radial direction). For Digital Video Disc (DVD) media, the first physical sector of the Data Zone is assigned a PSN of 030000h, which represents the beginning of the media's data zone and is located 24 mm from the center hole. PSNs increase by 1 for each physical sector that is advanced.

For Compact Disc (CD) media, the address of a section of an information track on the disk is given as the elapsed time from the start of the User Data Area to that section. This address contains three fields specified by minutes, seconds and fractions thereof (i.e., 1/75 of a second). This information can be to expressed in terms of PSNs since the PSN will increase by 1 for each 1/75 of a second change. Thus, the start of the User Data Area will correspond to a PSN of (0h), which is located at the position 25 mm from the center hole.

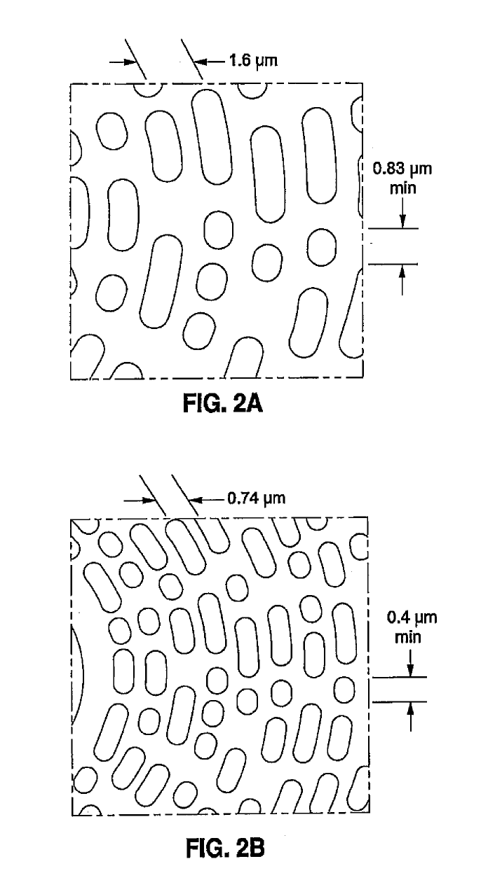

Each physical sector recorded on DVD media contains 38,688 bits, while each physical sector recorded on a CD will contain 57,624 bits. As shown in FIG. 2A, the track pitch of a CD is 1.6 μm and the minimum pit length is 0.83 μm (3 bits wide). FIG. 2B shows the track pitch of a DVD is 0.74 μm and the minimum pit length is 0.4 μm (3 bits wide). Therefore, it follows that the length of a single sector on a DVD can be computed as:

DVD PSN Length=38,688 bits*0.4 μm/3 bits=5,158.4 μm.

For a CD, the length of each sector can be computed as:

CD PSN Length=57,624 bits*0.83 μm/3 bits=15,942.6 μm.

Referring back to FIG. 1A, once the PSN length is known, the track number corresponding to the target position can be determined from the following deduction calculation equation:

$$Track\_number = \frac{\sqrt{\begin{matrix}{r}_{start}^{2} + \frac{( PSN\_target - PSN\_start ) * PSN\_length}{π} * \\ Track\_Pitch - {r}_{start}\end{matrix}}}{Track\_Pitch} \qquad ( 1 )$$

where,
PSN_target=the PSN at the target position and known from the seek instruction received at block 105;
PSN_start=the PSN at the start position of the Data Zone for the media in question (e.g., 030000h for DVD; 0h for CD, etc.);
rₛₜₐᵣₜ=the radius the PSN_start position (e.g., 24 mm for DVD; 25 mm for CD, etc.);
Track_Pitch=track pitch of the media in question (e.g., 0.74 μm for DVD; 1.6 μm for CD, etc.).

It should be appreciated that Eq. 1 may involve one or more approximations. Alternatively, one or more lookup tables may be used in lieu of Eq. 1 to convert a known PSN to the corresponding track number, thereby reducing the processing overhead associated with determining the target track number.

Once the track number of the target position has been determined (i.e., Track_number from Eq. 1 above), process 100 may continue to block 115 where the radius at the target position may be determined. Specifically, the radius at the target position may be computed using the following equation:

r_{target}=Track_number*Track_Pitch+rₛₜₐᵣₜ (2)

Since process 100 relates to a CLV device or CLV mode, the CLV at the target position will be known. However, the required CAV for the target position will need to be determined. To that end, process 100 may determine the unknown target position CAV at block 120 prior to the OPU even reaching the target position. This is possible since the radius at the target position will have been computed (block 115) and the CLV will be a known value. Thus, the following equation may be used to determine the CAV for the target position:

$${ω}_{target} = \frac{{v}_{target}}{{r}_{target}} \qquad ( 3 )$$

where,
ω_{target}=unknown CAV for target position;
ν_{target}=known CLV for the target position; and
r_{target}=radius at the target position.

Now that the target CAV speed is known, the spindle motor speed may be adjusted before the OPU even reaches the target position, thereby reducing the time for track pull-in. In particular, in order to smoothly adjust the spindle motor speed while the OPU is still in transition, the desired frequency generation signal corresponding to the target position may be determined at block 125. In certain embodiments, this may include determining the rotational speed of the spindle motor at its current position (i.e., before the seek instruction of block 105 is acted on) by detecting the frequency generation (FG) signal output from a spindle motor sensor, such as the FG sensor found in three-phase brushless spindle motors. Since the current FG signal frequency will be proportional to the speed of the rotating motor, the FG signal frequency corresponding to target spindle speed may be computed. In particular, the following equation may be used to determine the FG signal frequency at the target position:

$$\frac{Current\_FG \_Signal \_Freq}{Current\_CAV} = \frac{Target\_FG \_Signal \_Freq}{Target\_CAV} \qquad ( 4 )$$

where,
Current_FG_Signal_Freq=the current or pre jump FG signal frequency;
Current_CAV=the current or pre jump CAV;
Target_CAV=the calculated CAV at the target position; and
Target_FG_Signal_Freq=the unknown FG signal frequency at the target position.

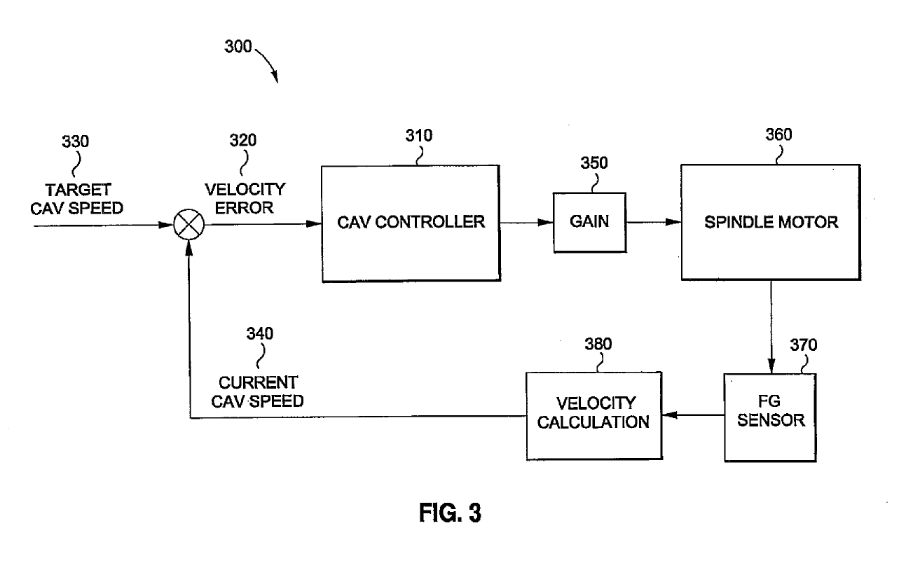

Once Equation (4) is used to solve for the target FG signal frequency (Target_FG_Signal_Freq), a proportional-plus-integral (PI) controller (e.g., CAV controller 310 of FIG. 3) may be used to adjust the spindle motor during the OPU jump to achieve (or approach) the desired rotational spindle speed prior to (or contemporaneously with) the OPU reaching the target position (block 130). As will be explained in more detail below with reference to FIG. 3, an FG sensor may be used in a feedback loop for adjusting the spindle motor speed to approximate the desired rotational speed for the target position. The actual spindle motor speed should preferably converge on the desired spindle motor speed corresponding to the target position during the OPU jump. While in certain embodiments the desired spindle speed may be reached no later than initiation of track pull-in at the target position, in other embodiments the actual spindle speed may be close enough to the desired spindle speed for the target position such that track pull-in may be performed quickly, thereby reducing overall seek time.

Referring now to FIG. 1B, depicted is another embodiment of a process for providing improved control of spindle speed during optical media seek operations. In this embodiment, process 135 assumes the device in question is a CAV device or is otherwise operating in CAV mode. To that end, process 135 begins at block 140 when an optical drive controller again receives a seek instruction to move the device's OPU from its current position to a target position along the media's surface. Following receipt of such a seek instruction, process 135 proceeds to block 145 where the current FG signal frequency corresponding to the current rotational speed of the spindle motor may be detected. As described above, an FG sensor, such as the type of sensor found in three-phase brushless spindle motors, may be used to detect the current FG signal frequency (i.e., Current_FG_Signal_Freq of Eq. (4)). The frequency of the FG signal will be proportional to the speed of the rotating motor. And since in the embodiment of FIG. 1B the current CAV and target CAV would be the same, Equation (4) can be used to solve for the unknown FG signal frequency at the target position (i.e., Target_FG_Signal_Freq) at block 150.

Once Equation (4) is used to solve for the target FG signal frequency (Target_FG_Signal_Freq), and as with the process 100 of FIG. 1A above, a PI controller (e.g., CAV controller 310 of FIG. 3) may be used to control the spindle motor during the OPU jump to achieve (or approach) the desired rotational spindle speed prior to (or contemporaneously with) the OPU reaching the target position (block 155). As previously described, an FG sensor may be used in a feedback loop for adjusting the spindle motor speed to approximate the desired rotational speed for the target position. The actual spindle motor speed should preferably converge on the desired spindle motor speed corresponding to the target position during the OPU jump. While in certain embodiments the desired spindle speed may be reached no later than initiation of track pull-in at the target position, in other embodiments the actual spindle speed may be close enough to the desired spindle speed for the target position such that track pull-in may be performed quickly, thereby reducing overall seek time.

FIG. 3 is a block diagram of a CAV control system 300 capable of implementing one or more aspects of the invention, including providing improved control of spindle speed during optical media seek operations. In particular, CAV control system 300 may be implemented in any optical media drive, such as a DVD player or a CD player. As shown, the CAV control system includes a CAV controller 310 that receives the difference or error 320 between the target CAV speed 330 and a currently-detected CAV speed 340. Based on the magnitude and/or the sign (plus or minus) of this velocity error, the CAN controller 310 may provide a corresponding control signal to gain circuitry 350 for driving the spindle motor 360 towards a desired rotational speed.

An FG sensor 370, such as the sensors found in three-phase brushless spindle motors, may be used to provide an FG signal to velocity calculation circuitry 380. In certain embodiments, the FG signal frequency may be proportional to the spindle motor's speed of rotation, and the velocity calculation circuitry 380 may be configured to convert the FG signal frequency to a corresponding CAV value (i.e., the current CAV speed 340). Thus, a feedback loop may be provided in which the FG sensor 370 and velocity calculation circuitry 380 together provide real-time feedback to the CAV controller of how close the actual spindle motor speed is to the target CAV speed 330. In certain embodiments, the CAV controller 310 may function as a PI controller for controlling the spindle motor 360 during OPU jumps in order to achieve or approach the desired rotational spindle speed prior the OPU reaching its target position. While the desired spindle speed may be reached no later than initiation of track pull-in at the target position, it should equally be appreciated that the actual spindle speed may be approaching the desired spindle speed at the time the target position is reached, thereby reducing the amount of time required to perform track pull-in.

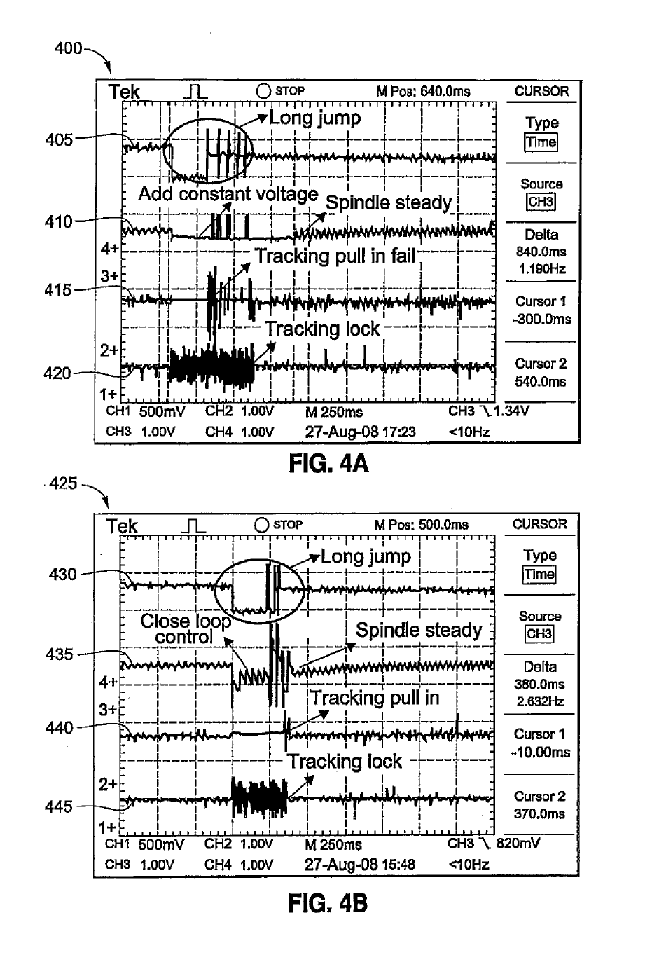

Referring now to FIGS. 4A-4B, depicted are screenshots of signal captures corresponding to a long OPU jump. In the case of FIG. 4A, screenshot 400 corresponds to the traditional practice of applying a constant voltage to the spindle motor during the jump. Since the spindle motor speed may be higher or lower than the required speed for the target position, tracking pull-in will take longer and may even fail since the spindle speed may be too high to lock. Signal 405 corresponds to the sled signal for the jump, signal 410 corresponds to the spindle output signal, signal 415 corresponds to the tracking actuator output signal and signal 420 is the tracking error signal.

In contrast, FIG. 4B depicts a screenshot 425 of a seek operation performed using the principles of the invention. In particular, the spindle motor speed is controlled during the actual jump based on the determined spindle speed at the target position, as detailed above. As can be seen in FIG. 4B, the sled signal 430, spindle output 435, tracking actuator output signal 440 and tracking error signal 445, all show that the overall time required to complete the long jump is reduced since tracking pull-in and tracking lock occur much more quickly than in the traditional case shown in FIG. 4A. In this fashion, since spindle motor speed is equal or at least close to the required speed when the OPU arrives at the target position, the track pull-in can be performed much quicker than with prior art systems, thereby decreasing the media player's overall seek time.

By way of providing a non-limiting comparison example, the following table includes test data compiled from 100 jumps where an OPU was directed to jump from Chapter 1 to Chapter 15 of a DVD:

| Time (seconds) | Worst Case | Best Case | Average |
|---|---|---|---|
| Traditional Approach | 20.18 | 0.97 | 3.81 |
| New Approach | 1.95 | 0.71 | 1.11 |

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for controlling a spindle motor during optical media seek operations, the method comprising the acts of:
receiving a seek instruction to move an optical pickup unit to a target position on an optical media surface;
determining a current signal frequency corresponding to a current spindle motor speed;
determining a target signal frequency corresponding to a desired spindle motor speed at the target position;
adjusting the current spindle motor speed towards the desired spindle motor speed based on the target signal frequency prior to the optical pickup unit reaching the target position.

2. The method of claim 1, wherein determining the signal frequency comprises sensing a rotational frequency of the spindle motor.

3. The method of claim 1, wherein the spindle motor is operating according to a constant angular velocity, and wherein determining the target signal frequency comprises computing the target signal frequency using the current signal frequency and the constant angular velocity.

4. The method of claim 1, wherein the spindle motor is operating according to a constant linear velocity, and wherein determining the target signal frequency further comprises:
determining a target track number for the target position;
determining a target radius corresponding to the target track number;
determining a desired constant angular velocity corresponding to the target radius; and
determining the target signal frequency for the target position based on the determined desired constant angular velocity.

5. The method of claim 4, wherein determining the target signal frequency comprises determining the target signal frequency based on the current signal frequency, the desired constant angular velocity and a current constant angular velocity.

6. The method of claim 1, wherein adjusting the current spindle motor speed comprises adjusting the current spindle motor speed to converge on the desired spindle motor speed during said moving of the optical pickup unit to the target position.

7. The method of claim 1, wherein adjusting the current spindle motor speed comprises adjusting the current spindle motor speed to reach the desired spindle motor speed no later than initiation of track pull-in at the target position.

8. The method of claim 1, further comprising generating a feedback back signal corresponding to the different between the current signal frequency and the target signal frequency.

9. The method of claim 8, wherein adjusting the current spindle motor speed comprises adjusting the current spindle motor speed based on said feedback signal.

10. A system for controlling a spindle motor during optical media seek operations comprising:
a frequency generation (FG) sensor configured to output a current FG signal corresponding to a current spindle motor speed; and
a controller coupled to the FG sensor, the controller configured to,
receive the current FG signal from the FG sensor,
determine a current signal frequency corresponding to the current FG signal,
determine a target signal frequency corresponding to a desired spindle motor speed at the target position on an optical media surface, wherein the target position corresponds to a seek instruction to move an optical pickup unit to the target position, and
adjust the current spindle motor speed towards the desired spindle motor speed prior to the optical pickup unit reaching the target position.

11. The system of claim 10, wherein the spindle motor is operating according to a constant angular velocity, and wherein the controller is configured to determine the target signal frequency using the current signal frequency and the constant angular velocity.

12. The system of claim 10, wherein the spindle motor is operating according to a constant linear velocity, and wherein the controller, in order to determine the target signal frequency, is further configured to,
determine a target track number for the target position,
determine a target radius corresponding to the target track number,
determine a desired constant angular velocity corresponding to the target radius, and
determine the target signal frequency for the target position based on the determined desired constant angular velocity.

13. The system of claim 12, wherein the controller is further configured to determine the target signal frequency based on the current signal frequency, the desired constant angular velocity and a current constant angular velocity.

14. The system of claim 10, wherein the controller is further configured to adjust the current spindle motor speed so as to converge on the desired spindle motor speed during said moving of the optical pickup unit to the target position.

15. The system of claim 10, wherein the controller is further configured to adjust the current spindle motor speed to reach the desired spindle motor speed no later than initiation of track pull-in at the target position.

16. The system of claim 10, wherein the controller is further configured to receive a feedback back signal corresponding to the different between the current signal frequency and the target signal frequency.

17. The system of claim 16, wherein the controller is further configured to adjust the current spindle motor speed based on said feedback signal.
